(19) United States
(12) Patent Application Publication
(10) Pub. No.: US 2006/0222897 A1
(43) Pub. Date: Oct. 5, 2006

(54) Discrete track media and method of manufacturing the same

(75) Inventors: Yoshiyuki Kamata, Tokyo (JP); Masatoshi Sakurai, Tokyo (JP); Shinobu Sugimura, Yokohama-shi (JP); Satoshi Shirotori, Fuchu-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/371,901

(22) Filed: Mar. 10, 2006

(30) Foreign Application Priority Data
Mar. 30, 2005 (JP) 2005-097971

(51) Int. Cl. G11B 5/64

(52) U.S. Cl. 428/826; 428/834; 427/127; 427/355; 204/192.15; 204/192.34

(57) ABSTRACT

A discrete track media has a nonmagnetic substrate, and a magnetic recording layer provided on the nonmagnetic substrate and having a data region including a recording track and a servo region including a preamble zone, an address zone and a burst zone, the data region and the servo region include patterns of a ferromagnetic layer forming protrusions and a nonmagnetic material filled into recesses between the patterns of the ferromagnetic layer, in which a height of the nonmagnetic material filled into the recesses in the data region is lower than that in the burst zone.

### CROSS-REFERENCE TO RELATED APPLICATIONS

This application is based upon and claims the benefit of priority from prior Japanese Patent Application No. 2005-097971, filed Mar. 30, 2005, the entire contents of which are incorporated herein by reference.

### BACKGROUND OF THE INVENTION

1. Field of the Invention

The present invention relates to a discrete track media which allows a magnetic head to fly appropriately and to which high-density magnetic recording can be carried out, as well as a method of manufacturing the discrete track media.

2. Description of the Related Art

In recent years, the improved track density of hard disk drives (HDD) has disadvantageously resulted in the interference between adjacent tracks. In particular, to reduce the fringing effect of magnetic fields from a magnetic head has become an important technical object.

To solve this problem, it is expected that a discrete track recording media (a DTR media) having physically separated recording tracks can be effectively used. The DTR media can suppress a side-erase phenomenon in which information in adjacent tracks is erased during recording and a side-read phenomenon in which information in adjacent tracks is read during reproduction. Thus, the DTR media is expected to significantly increase track density to enable high-density recording (see FIG. 1 in Jpn. Pat. Appln. KOKAI Publication No. 7-85406).

The DTR media has protrusions and recesses formed on the surface thereof as a result of processing of the magnetic layer. It is difficult to allow the magnetic head to fly stably over the media surface with protrusions and recesses. Thus, a method is known which comprises filling the recesses with SiO₂ by bias sputtering and removing excessive SiO₂ to make the surface flat (see IEEE Trans. Magn., Vol. 40, No. 4, 2510 (2004)).

The flying height of the magnetic head must be reduced in order to achieve high-density recording. The flying height of the magnetic head is in proportion to the square of linear velocity of the media. Consequently, there is a difference in flying height between an inner peripheral portion and outer peripheral portion of a disk. To solve this problem, a method has been proposed which comprises forming texture on the surface of the media to control the flying height of the magnetic head by making use of the protrusions and recesses of the texture, thus achieving a uniform flying height all over the disk surface (see FIG. 6 in Jpn. Pat. Appln. KOKAI Publication No. 4-113515).

As described above, the DTR media enables a reduction in the distance between the recording tracks. The DTR media is thus effective for high-density recording. However, the DTR media is only effective in reducing the distance between the recording tracks and can only improve the density in the cross-track direction. On the other hand, the only way to increase the recording density in the down-track direction is to improve the characteristics of the media before processing. A preferable media capable of dealing with high-density recording is a perpendicular recording film having a high coercivity which is expected to avoid thermal fluctuation associated with a reduction in the size of recording bits. Since a magnetic field generated by a magnetic head is limited, however, it is very difficult to record data to the high-coercivity media in the perpendicular recording system.

Thus, recording is carried out under a reduced flying height of the magnetic head, i.e., under a reduced magnetic spacing. However, the reduction in the flying height of the magnetic head increases the frequency with which the magnetic head contacts the media. This degrades the reliability of the magnetic recording device (HDD). When the magnetic head comes into contact with the media during an operation of reading servo signals, particularly burst signals, necessary to control the position of the magnetic head, tracking cannot be achieved, which prevents the HDD from functioning. Thus, a DTR media is desired in which the flying height of the magnetic head is smaller in data regions and larger in servo regions, particularly burst zones.

### BRIEF SUMMARY OF THE INVENTION

A discrete track media according to an aspect of the present invention comprises: a nonmagnetic substrate; and a magnetic recording layer provided on the nonmagnetic substrate and comprising a data region including a recording track and a servo region including a preamble zone, an address zone and a burst zone, the data region and the servo region include patterns of a ferromagnetic layer forming protrusions and a nonmagnetic material filled into recesses between the patterns of the ferromagnetic layer, wherein a height of the nonmagnetic material filled into the recesses in the data region is lower than that in the burst zone.

A method of manufacturing a discrete track media according to another aspect of the present invention comprises: forming a ferromagnetic layer and a protective layer on a nonmagnetic substrate; applying a resist to the protective layer; imprinting a stamper, having patterns of protrusions and recesses corresponding to a recording track, a preamble zone, an address zone and a burst zone, onto the resist so as to transfer the patterns to the resist; carrying out dry-etching to selectively remove bottoms of the recesses in the resist to which the patterns of the protrusions and recesses have been transferred; ion-beam etching the protective layer and the ferromagnetic layer using the patterned resist as a mask; carrying out sputtering to fill a nonmagnetic material into the recesses between patterns of the ferromagnetic layer with the patterned resist remained on the protective layer; and performing etchback to reduce a thickness of the nonmagnetic material.

### BRIEF DESCRIPTION OF THE SEVERAL VIEWS OF THE DRAWING

FIG. 1 is a plan view of a magnetic recording layer in a discrete track media according to an embodiment of the present invention;

FIGS. 2A and 2B are sectional views of the discrete track media according to an embodiment of the present invention, showing a difference in the height of the nonmagnetic material between the data region and the burst zone;

FIGS. 3A and 3B are sectional views of a discrete track media according to another embodiment of the present invention, showing a difference in the height of the nonmagnetic material between the data region and the burst zone;

FIGS. 4A and 4B are sectional views of a discrete track media according to yet another embodiment of the present invention, showing a difference in the height of the nonmagnetic material between the data region and the burst zone;

FIG. 5A is a perspective view of the discrete track media according to an embodiment of the present invention, showing the area ratio of the ferromagnetic layer to the nonmagnetic material in the data region;

FIG. 5B is a perspective view showing the area ratio of the ferromagnetic layer to the nonmagnetic material in the burst zone;

FIGS. 5C and 5D are sectional views showing a difference in the height of the nonmagnetic material between the data region and the burst zone;

FIGS. 6A, 6B, 6C, 6D, 6E, 6F, 6G and 6H are sectional views showing a method of manufacturing a discrete track media according to an embodiment of the present invention;

FIGS. 7A and 7B are sectional views showing a problem that may occur when protrusions and recesses are covered using a wet process with SOG;

FIG. 8 is a perspective view of a magnetic recording apparatus according to another embodiment of the present invention;

FIG. 9 is a plan view of the discrete track media produced according to Example 2; and

FIGS. 10A and 10B are sectional views of the discrete track media according to Example 2, showing an uneven surface of the data region and a flat surface of a zone other than the data region.

### DETAILED DESCRIPTION OF THE INVENTION

Embodiments of the present invention will be described below with reference to the drawings.

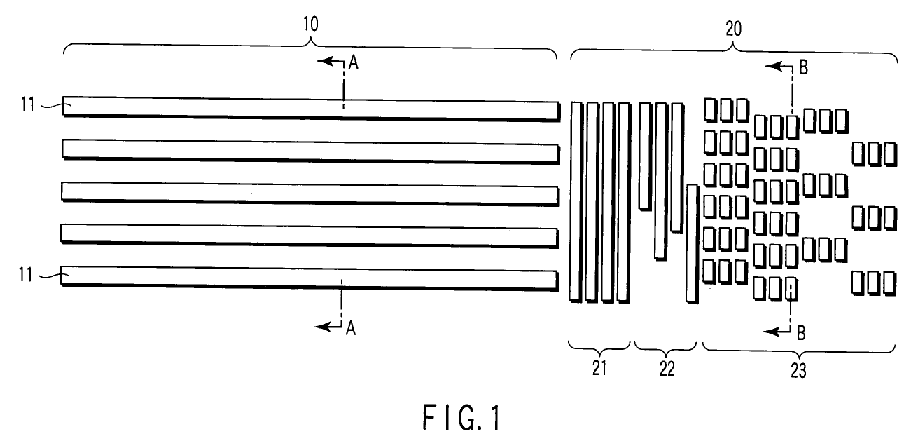

FIG. 1 shows a plan view of a magnetic recording layer in a discrete track media according to an embodiment of the present invention. As shown in FIG. 1, the magnetic recording layer comprises a data region 10 including recording tracks 11, and a servo region 20 including a preamble zone 21, an address zone 22 and a burst zone 23. These zones include patterns of a ferromagnetic layer forming protrusions and a nonmagnetic material filled into the recesses between the patterns of the ferromagnetic layer. Thus, the adjacent recording tracks are physically separated from one another by the nonmagnetic material. In embodiments of the present invention, a height of the nonmagnetic material filled into the recesses in the data region 10 is lower than that in the burst zone 23.

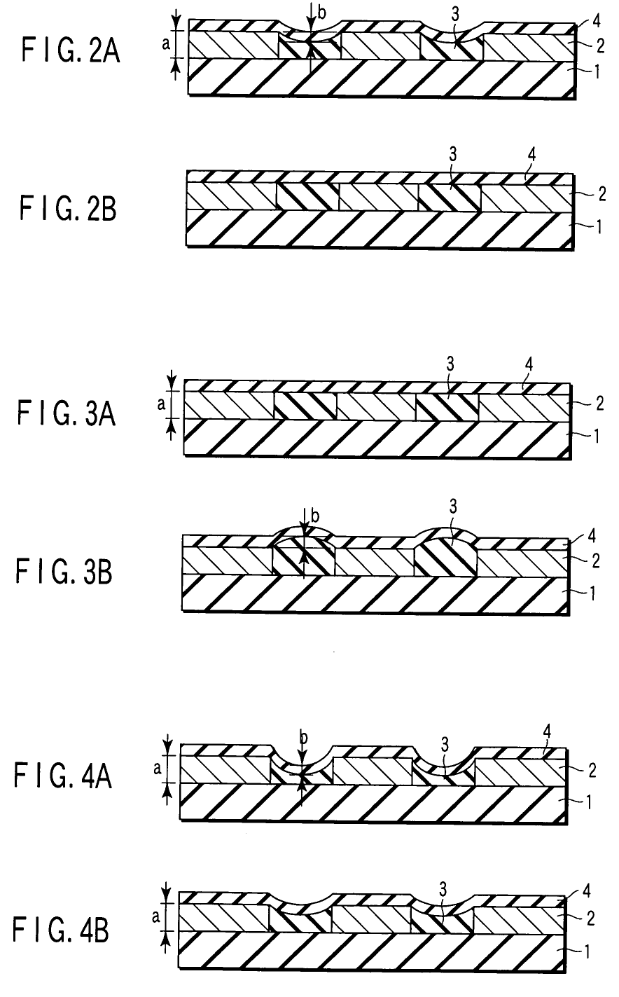

With reference to the sectional views in FIGS. 2A, 2B, 3A, 3B, 4A and 4B, a difference in the height of the nonmagnetic material between the data region 10 and the burst zone 23 will be specifically described. FIGS. 2A, 3A and 4A show cross sections of the data region, and FIGS. 2B, 3B and 4B show cross sections of the burst zone. All the drawings show that patterns of a ferromagnetic layer 2 are formed on a nonmagnetic substrate 1 and that a nonmagnetic material 3 is filled into the recesses between the patterns of the ferromagnetic layer 2. These drawings further show a carbon protective film 4 formed on the surface of the ferromagnetic layer 2 and nonmagnetic material 3.

In the burst zone 23 shown in FIG. 2B, the surfaces of the ferromagnetic layer 2 and the nonmagnetic material 3 have the same height. However, in the data region 10 shown in FIG. 2A, the nonmagnetic material 3 is lower than the ferromagnetic layer 2. Accordingly, the height of the nonmagnetic material 3 in the data region 10 is lower than that in the burst zone 23.

In the data region 10 shown in FIG. 3A, the surfaces of the ferromagnetic layer 2 and the nonmagnetic material 3 have the same height. However, in the burst zone 23 shown in FIG. 3B, the nonmagnetic material 3 rises above the ferromagnetic layer 2. Accordingly, the height of the nonmagnetic material 3 in the data region 10 is lower than that in the burst zone 23.

In both the data region 10 shown in FIG. 4A and the burst zone 23 shown in FIG. 4B, the nonmagnetic material 3 is lower than the ferromagnetic layer 2. However, the height of the nonmagnetic material 3 in the data region 10 is lower than that in the burst zone 23.

When the height of the nonmagnetic material 3 filled into the recesses in the data region 10 is thus lower than that in the burst zone 23, the flying height of the magnetic head can be reduced in the data region 10 to facilitate write operations for a high-coercivity media. On the other hand, in the burst zone 23, the flying height of the magnetic head can be increased to reduce the possibility of a head crash, thus improving reliability.

Here, since servo data is physically formed into protrusions, it suffices to magnetize the protrusions in one direction to obtain servo signals. That is, the servo signals do not written by the magnetic head, and therefore, the flying height of the magnetic head need not be reduced in the servo region 23.

In the discrete track media according to the embodiments of the present invention, it is preferable that the difference b in the height between the nonmagnetic material filled into the recesses in the burst zone and that in the burst zone and a depth a of the recesses between the patterns of the ferromagnetic layer satisfy the relationship: 0<b≦a/12. The reason will be explained below.

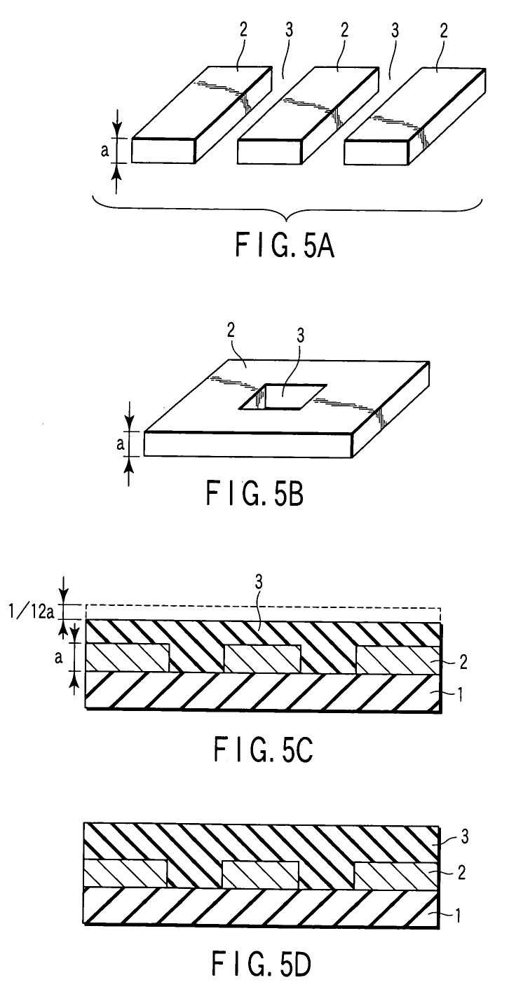

The data region is designed so as to maximize the signal-to-noise ratio (SNR) of read signals. For example, as shown in FIG. 5A, the minimum ratio of the width of the tracks to the width of grooves is set to 2 to 1. When the width of the grooves is increased over the above ratio, the volume of the ferromagnetic layer corresponding to the recording track will be decreased. This reduces the SNR of the read signals. Further, as shown in FIG. 5B, the burst zone is designed so that the area ratio of the ferromagnetic layer 2 to the nonmagnetic material 3 per unit area is set to 3 to 1. Reducing the area ratio of the ferromagnetic layer in the burst zone precludes the SNR of the servo signals from being increased.

According to the above design, the maximum area ratio of the nonmagnetic material/ferromagnetic layer is 1/3 in the data region and 1/4 in the burst zone. If the nonmagnetic material is filled into the recesses (having the depth a) between patterns of the ferromagnetic layer in the zones designed to have such area ratios of the nonmagnetic material to the ferromagnetic layer, then the height to which the nonmagnetic material is filled is in inverse proportion to the area ratio of the nonmagnetic material to the ferromagnetic layer. Thus, the maximum difference b in the height of the nonmagnetic material between the burst zone shown in FIG. 5D and the data region shown in FIG. 5C is b=a/12. Therefore, the DTR media is designed so as to satisfy the particular relationship, 0<b≦a/12, a good SNR is obtained for both read signals and servo signals.

In the discrete track media according to the embodiments of the present invention, the value of the difference b between the height of the nonmagnetic material 3 filled into the recesses in the burst zone 23 and that in the data region 23 is preferably 15 nm or less. The reason will be explained below.

Since the degree to which the flying height is changed increases consistently with the difference b in the height of the nonmagnetic material between the burst zone and the data region, a larger difference b makes it possible to reduce the possibility of a head crash. However, an excessively significant change in flying height precludes the head suspension from absorbing the change, bringing about vibration of the magnetic head itself. The vibration of the magnetic head becomes a noise source to degrade the SNR of read signals, which is not preferable. The vibration of the magnetic head can be prevented when the difference b in the height of the nonmagnetic material is 15 nm or less.

In the discrete track media according to the embodiments of the present invention, SiO₂ or carbon (C) is preferably used as a nonmagnetic filling agent filled into the recesses between the patterns of the magnetic layer. In manufacturing a DTR media, a method of depositing a ferromagnetic layer and other layers on a substrate, applying a resist to the ferromagnetic layer, imprinting a stamper on the resist to transfer patterns of protrusions and recesses may be used. In this case, selection of the resist is important. In general, a novolac-based photoresist (for example, S1801 available from Shipley) can be conveniently used. However, the novolac-based photoresist fails to exhibit excellent transfer performance in an imprinting step. When SOG (spin-on-glass) is used as a resist, SOG exhibits excellent transfer performance and helps form rectangular patterns. Thus, the DTR media is suitably manufactured via an imprinting step using SOG. After the imprinting step, the ferromagnetic layer is etched using SOG to which patterns of protrusions and recesses have been transferred as a mask. In this case, SOG remains on the ferromagnetic layer as mask residues.

If the novolac-based photoresist is used, the mask residues are stripped by RIE (reactive ion-etching) using an oxygen gas. However, it has been known that, during this step, the top of the ferromagnetic layer suffers etching damage.

Here, if SiO₂ is used as a nonmagnetic filling agent filled into the recesses between the patterns of the magnetic layer, the filling step can be achieved without performing a mask stripping step as in the prior art, because SOG of the mask residue is substantially the same as SiO₂ of the nonmagnetic filling agent. Thus, the use of SiO₂ as the nonmagnetic filling agent eliminates the need for the step of stripping the mask residues. This makes it possible to reduce the time required for manufacturing steps, which significantly reduces a cost and a manufacturing time. It is also possible to significantly suppress damage to the top of the ferromagnetic layer. Similar effects can be produced by using C (carbon) as a nonmagnetic filling agent in place of SiO₂.

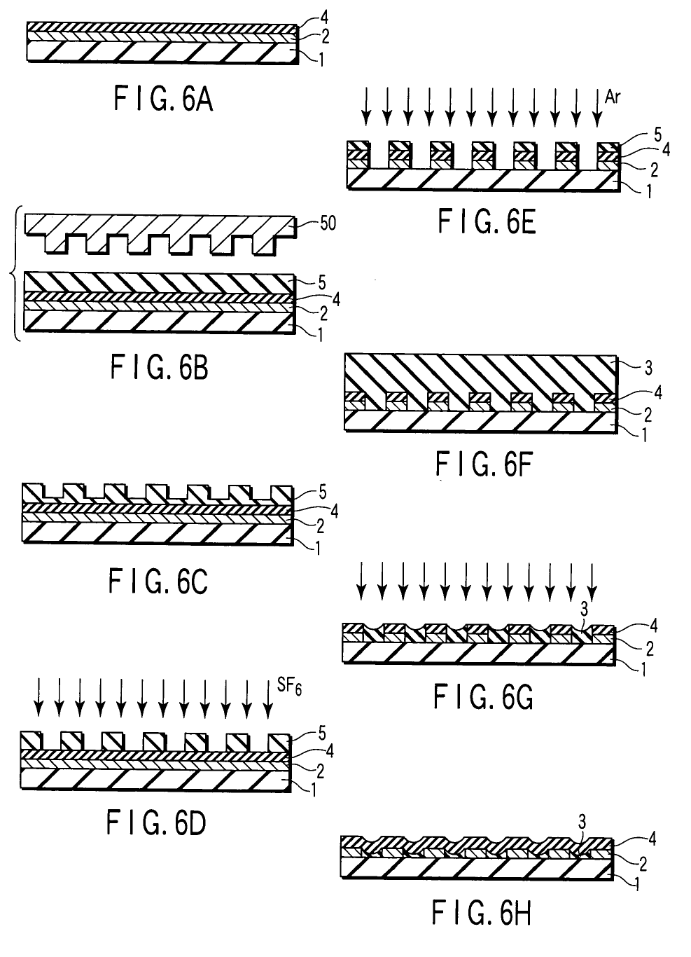

Now, with reference to FIGS. 6A, 6B, 6C, 6D, 6E, 6F, 6G and 6H, a method of manufacturing a discrete track media according to an embodiment of the present invention will be briefly described.

The ferromagnetic layer 2 with perpendicular magnetic anisotropy and a carbon protective layer 4 are deposited on a substrate 1 (FIG. 6A). SOG 5 is applied to the carbon protective layer 4. A surface of a stamper 50 on which the patterns of protrusions and recesses are formed is placed opposite SOG 5 (FIG. 6B). Imprinting is carried out to transfer the patterns of protrusions and recesses of the stamper 50 to SOG 5 (FIG. 6C). Reactive ion etching (RIE) using SF₆ or CF₄ is carried out to remove SOG 5 from the bottoms of the recesses (FIG. 6D). Ion milling using Ar is carried out to etch the carbon protective layer 4 and the ferromagnetic layer 2 (FIG. 6E). SiO₂ as the nonmagnetic material 3 is deposited by sputtering (FIG. 6F). Etchback is performed until the carbon protective layer 4 is exposed to reduce the thickness of the nonmagnetic material 3 (FIG. 6G). The carbon protective layer 4 is deposited again (FIG. 6H).

As described above, in the method of manufacturing a DTR media according to an embodiments of the present invention, the recesses are filled with the nonmagnetic material by sputtering in the step shown in FIG. 6F. A bias may be applied to the substrate in the sputtering as required. When sputtered SiO₂ is deposited so as to fill the recesses, the filling amount varies depending on the density of the patterns. For example, if the area ratio of the nonmagnetic material to the ferromagnetic layer is designed to be 1/3 in the data region and to be 1/4 in the burst zone as described above, when SiO₂ is deposited by sputtering, the data region where an area of the nonmagnetic material (recesses) is relatively large has a smaller filling thickness than the burst zone, because an equal volume of SiO₂ is deposited per unit area. Subsequently, the DTR media according to the present invention can be manufactured by performing an etchback step to reduce the thickness of the nonmagnetic material. The density of the patterns may be controlled in order to adjust the difference b in the height of the nonmagnetic material between the burst zone and the data region.

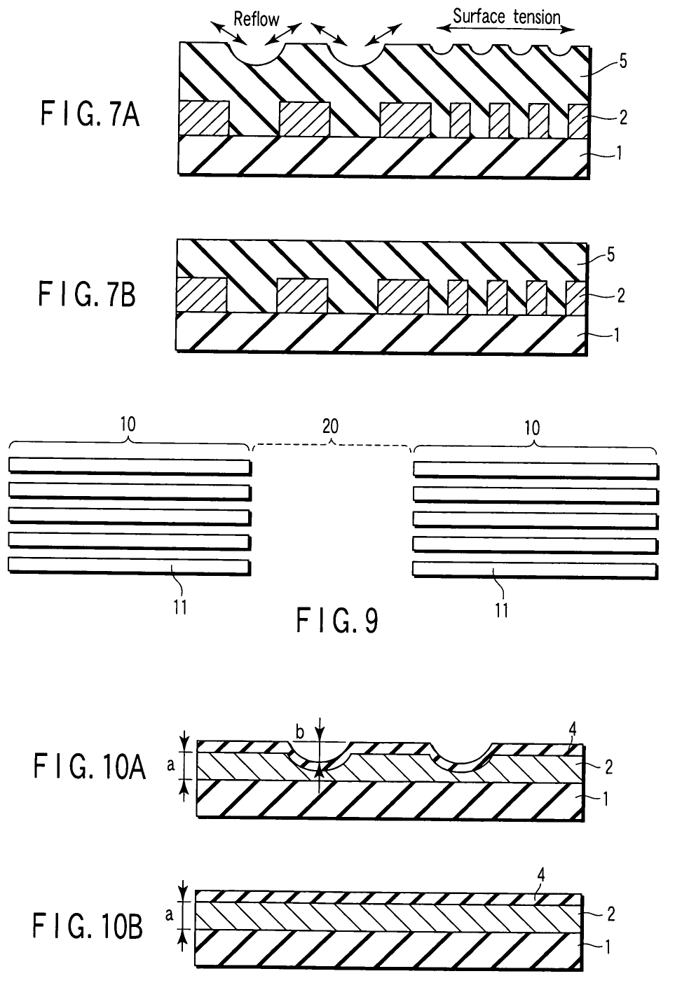

In contrast, if the recesses are filled with SOG 5 by a wet process, surface tension and reflow effect act on the surface of SOG 5 to form a flat surface all over the disk surface as shown in FIGS. 7A and 7B. Therefore, the use of the wet process with SOG 5 precludes filling structures from being varied depending on the zones as in the case of the DTR media according to the embodiments of the present invention.

Materials used for the discrete track media according to the embodiments of the present invention will be described below.

(Substrate)

The substrate may be, for example, a glass substrate, an Al alloy substrate, a ceramic substrate, a carbon substrate, a Si single-crystal substrate having an oxide on the surface thereof, and those substrates coated with a plating layer such as NiP. The glass substrate may be formed of amorphous glass or crystallized glass. The amorphous glass includes soda lime glass and aluminosilicate glass which are generally used. The crystallized glass includes lithium-based crystallized glass. The ceramic substrate includes a sintered body mainly formed of aluminum oxide, aluminum nitride or silicon nitride, or a material obtained by fiber-reinforcing the sintered body.

It should be noted that the following describes only sputtering as a method of depositing a thin film on the substrate. However, the similar effects to the sputtering can be provided when vacuum deposition or electroplating is used.

(Soft Underlayer)

The soft underlayer (SUL) is provided so as to pass a recording field from a magnetic head such as a single-pole head to magnetize the perpendicular recording layer therein and to return the recording field to a return yoke arranged near the recording magnetic pole. That is, the soft underlayer provides a part of the function of the write head, serving to apply a steep perpendicular magnetic field to the recording layer so as to improve recording and reproduction efficiency.

The soft underlayer may be made of a material containing at least one of Fe, Ni, and Co. Such materials include an FeCo alloy such as FeCo and FeCoV, an FeNi alloy such as FeNi, FeNiMo, FeNiCr and FeNiSi, an FeAl alloy and FeSi alloy such as FeAl, FeAlSi, FeAlSiCr, FeAlSiTiRu and FeAlO, an FeTa alloy such as FeTa, FeTaC and FeTaN, and an FeZr alloy such as FeZrN.

The soft underlayer may be made of a material having a microcrystalline structure or a granular structure containing fine grains dispersed in a matrix such as FeAlO, FeMgO, FeTaN and FeZrN, each containing 60 at % or more of Fe.

The soft underlayer may be made of other materials such as a Co alloy containing Co and at least one of Zr, Hf, Nb, Ta, Ti and Y. The material preferably contains 80 at % or more of Co. An amorphous layer can be easily formed when the Co alloy is deposited by sputtering. The amorphous soft magnetic material exhibits very excellent soft magnetism because of free of magnetocrystalline anisotropy, crystal defects and grain boundaries. The use of the amorphous soft magnetic material may reduce noise of the media. Preferred amorphous soft magnetic materials include, for example, a CoZr—, CoZrNb— and CoZrTa-based alloys.

Another underlayer may be provided under the soft underlayer in order to improve the soft underlayer in the crystallinity or in the adhesion to the substrate. Materials for the underlayer include Ti, Ta, W, Cr, Pt, and an alloy thereof, and oxide and nitride containing the above metal. An intermediate layer may be provided between the soft underlayer and the recording layer. The intermediate layer serves to break exchange coupling interaction between the soft underlayer and the recording layer and to control the crystallinity of the recording layer. Materials for the intermediate layer include Ru, Pt, Pd, W, Ti, Ta, Cr, Si and an alloy thereof, and oxide and nitride containing the above metal. To prevent spike noise, the soft underlayer may be divided into layers antiferromagnetically coupled with each other through a Ru layer with a thickness of 0.5 to 1.5 nm sandwiched therebetween. Alternatively, the soft underlayer may be exchange-coupled with a pinning layer made of a hard magnetic layer with in-plane anisotropy such as CoCrPt, SmCo and FePt or an antiferromagnetic layer such as IrMn and PtMn. In this case, to control the exchange coupling force, a magnetic layer such as Co or a nonmagnetic layer such as Pt may be provided on and under the Ru layer.

It is preferable that the microstructure of the soft underlayer is similar to that of the ferromagnetic layer in view of control of the crystallinity or the microstructure. However, the microstructure of the soft underlayer may be made different from that of the ferromagnetic layer on purpose in a case where the magnetic property thereof is regarded as important. For example, there may be used a combination of an amorphous soft underlayer and a crystalline ferromagnetic layer or a combination that the crystal properties of the two layers are reversed to the above. The soft underlayer may be of a so-called granular structure in which fine grains of a soft magnetic material are present in a nonmagnetic matrix. Also, the soft underlayer may be constituted by a plurality of layers deferring in magnetic properties such as a multilayer of soft magnetic layers and nonmagnetic layers.

It should be noted that the direction of the magnetic anisotropy in the soft underlayer may be any of the perpendicular direction, the in-plane circumferential direction or the in-plane radial direction except for in the write operation. The soft underlayer may have such a coercivity that, in the write operation, the magnetization direction (the spin direction) is varied by the field of the single-pole head and a closed magnetic loop can be formed. The coercivity of the soft underlayer is preferably several kOe or less, more preferably 1 kOe or less, and further more preferably 50 Oe or less.

(Perpendicular Magnetic Recording Layer)

The perpendicular recording layer is preferably made of a material mainly containing Co, containing at least Pt, containing Cr as required, and further containing an oxide. Particularly suitable oxide is silicon oxide and titanium oxide. The perpendicular recording layer preferably has a structure in which magnetic grains, i.e., crystalline grains with magnetism are dispersed in the layer. The magnetic grains preferably have a columnar configuration penetrating the perpendicular recording layer. Such a structure improves orientation and crystallinity of the magnetic grains in the perpendicular recording layer, making it possible to provide a signal-to-noise ratio (SNR) suitable for high-density recording.

The amount of oxide is important for obtaining the above structure. The oxide content to the total amount of Co, Pt and Cr is preferably 3 mol % or more and 12 mol % or less, more preferably 5 mol % or more and 10 mol % or less. If the oxide content of the perpendicular recording layer is within the above range, the oxide is precipitated around the magnetic grains, making it possible to isolate the magnetic grains and to reduce their sizes. If the oxide content exceeds the above range, the oxide remains in the magnetic grains to degrade the orientation and crystallinity. Moreover, the oxide is precipitated over and under the magnetic grains to prevent formation of the columnar structure penetrating the perpendicular recording layer. On the other hand, if the oxide content is less than the above range, the isolation of the magnetic grains and the reduction in their sizes are insufficient. This increases media noise in reproduction and makes it impossible to obtain a SNR suitable for high-density recording.

The Cr content of the perpendicular recording layer is preferably 0 at % or more and 16 at % or less, more preferably 10 at % or more and 14 at % or less. When the Cr content is within the above range, high magnetization can be maintained without unduly reduction in the uniaxial magnetic anisotropy constant Ku of the magnetic grains. This brings read/write characteristics suitable for high-density recording and sufficient thermal fluctuation characteristics. If the Cr content exceeds the above range, Ku of the magnetic grains decreases to degrade the thermal fluctuation characteristics as well as to degrade the crystallinity and orientation of the magnetic grains. As a result, the read/write characteristics may be degraded.

The Pt content of the perpendicular recording layer is preferably 10 at % or more and 25 at % or less. When the Pt content is within the above range, the perpendicular recording layer provides a required uniaxial magnetic anisotropy constant Ku. Moreover, the magnetic grains exhibit good cyrstallinity and orientation, resulting in thermal fluctuation characteristics and read/write characteristics suitable for high-density recording. If the Pt content exceeds the above range, a layer of an fcc structure may be formed in the magnetic grains to degrade the crystallinity and orientation. On the other hand, if the Pt content is less than the above range, it is impossible to obtain Ku to provide thermal fluctuation characteristics suitable for high-density recording.

The perpendicular recording layer may contain not only Co, Pt, Cr and an oxide but also one or more additive elements selected from the group consisting of B, Ta, Mo, Cu, Nd, W, Nb, Sm, Tb, Ru and Re. These additive elements enable to facilitate reduction in the sizes of the magnetic grains or to improve the crystallinity and orientation. This in turn makes it possible to provide read/write characteristics and thermal fluctuation characteristics more suitable for high-density recording. These additive elements may preferably be contained totally in 8 at % or less. If the total content exceeds 8 at %, a phase other than the hcp phase is formed in the magnetic grains. This degrades crystallinity and orientation of the magnetic grains, making it impossible to provide read/write characteristics and thermal fluctuation characteristics suitable for high-density recording.

Other materials for the perpendicular recording layer include a CoPt alloy, a CoCr alloy, a CoPtCr alloy, CoPtO, CoPtCrO, CoPtSi and CoPtCrSi. The perpendicular recording layer may be formed of a multilayer film containing a Co film and a film of an alloy mainly including an element selected from the group consisting of Pt, Pd, Rh and Ru. The perpendicular recording layer may be formed of a multilayer film such as CoCr/PtCr, CoB/PdB and CoO/RhO, which are prepared by adding Cr, B or O to each layer of the above multilayer film.

The thickness of the perpendicular recording layer preferably ranges between 5 nm and 60 nm, more preferably between 10 nm and 40 nm. The perpendicular recording layer having a thickness within the above range is suitable for high-density recording. If the thickness of the perpendicular recording layer is less than 5 nm, read output tends to be so low that a noise component becomes relatively high. On the other hand, if the thickness of the perpendicular recording layer exceeds 40 nm, read output tends to be so high as to distort waveforms. The coercivity of the perpendicular recording layer is preferably 237,000 A/m (3,000 Oe) or more. If the coercivity is less than 237,000 A/m (3,000 Oe), the thermal fluctuation tolerance may be degraded. The perpendicular squareness of the perpendicular recording layer is preferably 0.8 or more. If the perpendicular squareness is less than 0.8, the thermal fluctuation tolerance tends to be degraded. The perpendicular recording layer may include an in-plane magnetic anisotropy component as long as the main magnetic anisotropy component is the perpendicular component.

The perpendicular recording layer is preferably made of a composite material constituted by magnetic grains and a nonmagnetic material intervening therebetween, because such a structure enables high-density recording using the magnetic grains as a reversal unit. However, in the case where the data region is patterned, the presence of the nonmagnetic material is not always necessary. Also, in this case, the perpendicular recording layer may be made of continuous amorphous magnetic material such as an alloy of rare earth-transition metal.

(Protective Layer)

The protective layer serves to prevent corrosion of the perpendicular recording layer and to prevent damage to the media surface when the magnetic head comes into contact with the media. Materials for the protective layer include, for example, C, SiO₂ and ZrO₂. The protective layer preferably has a thickness of 1 to 10 nm. When the thickness of the protective layer is within the above range, the distance between the head and the media can be reduced, which is suitable for high-density recording. Carbon can be classified into sp²-bonded carbon (graphite) and sp³-bonded carbon (diamond). The sp³-bonded carbon is more excellent in durability and anticorrosion but is inferior in surface smoothness to graphite. Normally, carbon is deposited by sputtering using a graphite target. This method forms amorphous carbon in which the sp²-bonded carbon (graphite) and sp³-bonded carbon are mixed. The amorphous carbon containing the sp³-bonded carbon in a high ratio is referred to as diamond-like carbon (DLC). The DLC exhibits excellent durability and anticorrosion and also is excellent in the surface smoothness because it is amorphous. In chemical vapor deposition (CVD), DLC is generated through excitation and decomposition of raw material gases in plasma and reaction of the decomposed species, so that DLC further rich in the sp³-bonded carbon can be produced.

Now, an example of a method of patterning a discrete track media will be described more specifically.

<Manufacture of Stamper>

First, a master plate used as an original of the pattern is prepared. A silicon substrate is coated with a photosensitive resin, and then the photosensitive resin is irradiated with an electron beam to form a latent image. The latent image is developed to form patterns of protrusions and recesses. The patterns are formed with use of an electron beam lithography apparatus comprising a signal source that irradiates the photosensitive resin on the substrate with the electron beam at a predetermined timing, and a stage that moves the substrate at high accuracy synchronously with the signal source.

A nickel conductive film is deposited on the prepared resist master by an ordinary sputtering method. Then, a nickel electroplated film with a thickness of about 300 μm is formed on the conductive film by electroplating. For example, high-concentration nickel sulfamate plating liquid (NS-160), available from Showa Chemical Industry Co., Ltd., is used in the electroplating. The electroplating conditions are as follows:

nickel sulfamate: 600 g/L,

boric acid: 40 g/L,

surfactant (sodium lauryl sulfate): 0.15 g/L,

liquid temperature: 55° C.,

pH: 3.8 to 4.0, and

current density: 20 A/dm².

After that, the electroplated film is stripped from the resist master and thus a stamper that includes the conductive film, electroplated film and resist residue is obtained. Then, the resist residue is removed by oxygen plasma ashing. For example, the oxygen plasma ashing is carried out at 100 W for 10 minutes in a chamber to which oxygen gas is introduced at 100 mL/min to adjust the internal pressure to 4 Pa.

The resultant father stamper itself can be used as an imprinting stamper. However, the aforementioned electroplating process is carried out on the father stamper repeatedly to replicate a great number of stampers in the following manner. First, an oxygen plasma ashing similar to the step of removing the resist residue is carried out and thus an oxide passivation film is formed on the surface of the father stamper. The father stamper is processed under 200 W for 3 minutes, in a chamber to which oxygen gas is introduced at 100 mL/min to adjust the interior pressure to 4 Pa. After that, a nickel electroplated film is formed in the same manner as described above by electroplating. Then, the electroplated film is stripped from the father stamper, and thus a mother stamper, which is a reversed form of the father stamper, is obtained. By repeating the processes for forming the mother stamper from the father stamper, 10 or more mother stampers having the same form are obtained.

Thereafter, in a similar manner to those procedures of obtaining a mother stamper from the father stamper, an oxide passivation film is formed on the surface of a mother stamper, an electroplated film is formed on the mother stamper, and then the electroplated film is stripped to obtain a son stamper, which has the same patterns protrusions and recesses as those of the father stamper.

<Imprinting>

The (son) stamper is subjected to ultrasonic cleaning with acetone for 5 minutes. Then, the stamper is immersed in a solution prepared by diluting a chlorine-based fluorocarbon resin-containing silane coupling agent, i.e., fluoroalkylsilane [CF₃(CF₂)₇CH₂CH₂Si(OMe)₃] (TSL8233 manufactured by GE Toshiba Silicones) with ethanol to 2% as a fluorine-based releasing agent. Then, the solution is blown with a blower and the stamper is annealed in a nitrogen atmosphere at 120° C. for one hour.

On the other hand, a magnetic disk is spin-coated with SOG (spin-on-glass) used as a resist. SOGs can be categorized, according to the chemical structure of siloxane, to silica glass, an alkylsiloxane polymer, an alkylsilsesquioxane polymer (MSQ), a hydrogenated silsesquioxane polymer (HSQ), a hydrogenated alkylsiloxane polymer (HOSP), etc. For example, a solution prepared by diluting T-7 of Tokyo Ohka Kogyo Co., Ltd. and FOX of Dow Corning Corporation with methylisobutylketone (MIBK) five times is used as SOG. After the SOG application, the magnetic disk is placed in a oven and pre-baked at 100° C. for 20 minutes to evaporate the solvent, thereby maintaining the SOG at appropriate hardness.

Then, the stamper on which patterns of recording tracks and servo regions are formed is pressed onto the resist (SOG) on the magnetic disk at 450 bar for 60 seconds to transfer the patterns to the resist.

<Media Etching>

In order to remove SOG resist residues at the bottoms of recesses on the magnetic disk, RIE using SF₆ gas is performed. A fluorine-based gas, for example, fluorocarbon such as CF₄, CHF₃ and C₂F₆ may be used instead of SF₆. However, the RIE using the fluorocarbon has a drawback that a re-deposited product containing teflon (a CF₂ polymerized product) is likely to be created. The RIE using SF₆ is preferred because it does not create a re-deposited product. In order to remove the SOG resist residues without deforming the configuration of protrusions of the SOG resist formed by imprinting, the RIE is preferably preformed under low-pressure and low-temperature conditions. For example, the removal of resist residue is performed under the following conditions: 100 W of power, 2 mTorr of chamber pressure, and 150° C. of process temperature.

Subsequently, the magnetic disk is etched by argon ion-milling. In order to avoid damages on the ferromagnetic recording layer, the ion-milling is preferably performed under low-voltage and low-current conditions. For example, the magnetic film is processed under the following conditions: 2.5×10⁻⁴ Torr of chamber pressure, 400V of accelerating voltage, and 40 mA of current. At this time, etching is carried out with varying the ion incident angle to 30° and 70° for suppressing re-deposition.

<Filling of Recesses>

The recesses are filled with SiO₂ or carbon deposited by sputtering so as to flatten the surface of the processed DTR media. At this time, a RF bias may be applied to the substrate. For example, SiO₂ is deposited to a thickness of 100 nm by bias-sputtering under the following conditions: 100 W of substrate bias, 500 W of target voltage, and 0.2 Pa of sputtering pressure. However, deposition of SiO₂ by bias-sputtering may bring about degraded surface flatness due to dust occurring. In a case where SiO₂ is deposited by normal sputtering without applying a substrate bias, dust occurring can be avoided, although it is necessary to deposit SiO₂ with a relatively large thickness in order to obtain a flat surface. In a case where carbon is used as the nonmagnetic filling agent, carbon can be deposited either by bias-sputtering or by normal sputtering because the problem of dust occurring is irrelevant.

Subsequently, etchback is performed by argon ion-milling. The etchback may be performed by RIE using a fluorine-based gas. However, the RIE using the fluorine-based gas is not preferred because, in a stage of over-etching where the surface of the ferromagnetic layer is exposed, only SiO₂ used as the filling agent is etched. Therefore, it is preferable to use the argon ion-milling capable of etching any material. For example, etching is performed under the following conditions: 2.5×10⁻⁴ Torr of chamber pressure, 400V of accelerating voltage, and 40 mA of current.

(Magnetic Recording Apparatus)

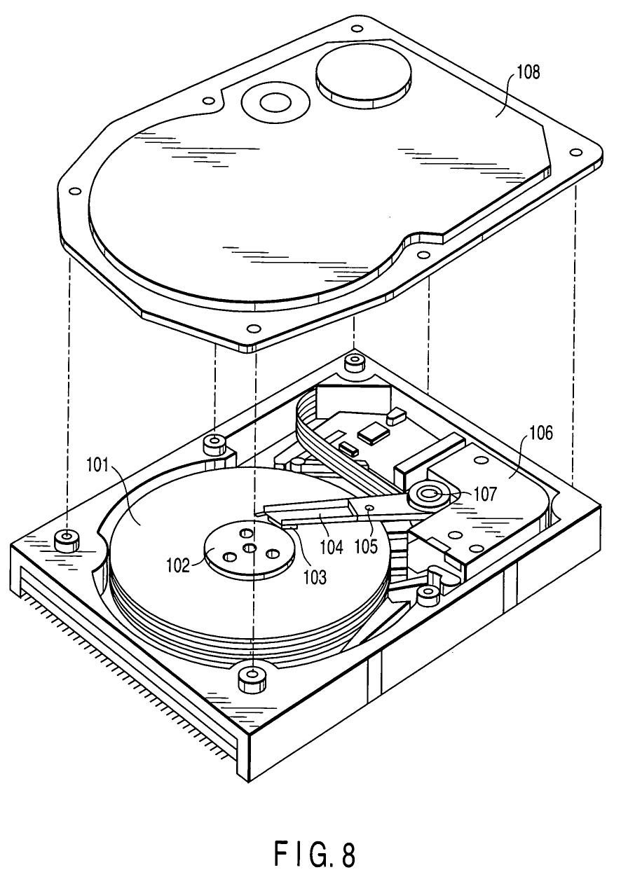

FIG. 8 is a perspective view of a magnetic recording apparatus according to another embodiment of the present invention. The magnetic disk apparatus comprises a magnetic disk 101, a slider 103 in which a magnetic head is fabricated, a head suspension assembly (a suspension 104 and an arm 105), an actuator 106, and a circuit board, all these components being provided inside a chassis.

The magnetic disk 101 is mounted on and rotated by a spindle motor 102. Various digital data are recorded to the magnetic disk 101 with a perpendicular magnetic recording system. The magnetic head is of what is called an integrated type comprising a write head having a single-pole structure and a read head having a GTR film or a TMR film provided between shields which are fabricated on the common slider 103.

The head suspension assembly supports the magnetic head opposite the recording surface of the magnetic disk 101. The actuator 106 uses a voice coil motor (VCM) to place the magnetic head 101 at an arbitrary radial position above the magnetic disk 101 via the head suspension assembly. The circuit board comprises a head IC to generate driving signals for the actuator 106 and control signals for controlling read and write operations performed by the magnetic head.

### EXAMPLES

### Example 1

A disk stamper with 100 sectors of recording tracks and servo regions was formed by electron-beam exposure. The stamper was designed so that the area ratio of the ferromagnetic layer to the nonmagnetic material was 3 to 1 in the data region and 4 to 1 in the burst zone. The stamper was used to produce a discrete track media according to the method shown in FIGS. 6A to 6H, as described below.

A soft magnetic layer of CoZrNb was formed on a glass substrate to a thickness of about 200 nm. A Ru underlayer for orientation control was deposited to a thickness of about 20 nm by sputtering. A ferromagnetic layer formed of CoCrPt alloy added with SiO₂ was then deposited to a thickness of about 20 nm. To prevent natural oxidation, a carbon protective film was deposited on the surface of the ferromagnetic layer to a thickness of about 4 nm. The media was determined to have a coercivity of 5 kOe on the basis of a Kerr hysteresis loop. A resist of SOG was formed so as to have a thickness of about 100 nm. The stamper was used to carry out imprinting to form patterns. The imprint residues at the bottoms of recesses were removed by SF₆ RIE. The ferromagnetic layer was etched by Ar ion-milling. SiO₂ was deposited to a thickness of about 200 nm to fill the recesses. Then, SiO₂ was etched back by Ar ion-milling. A carbon protective film was then formed to a thickness of about 4 nm by CVD. A lubricant was then applied to the carbon protective film.

Thus, a DTR media as shown in FIGS. 2A and 2B was manufactured. Measurements of sectional TEM indicated that the ferromagnetic layer and the nonmagnetic material (SiO₂) had the same height in the burst zone but that the nonmagnetic material (SiO₂) was lower than the ferromagnetic layer by 1.5 nm in the data region. That is, the difference b in height between SiO₂ filled into the recesses in the burst zone and that in the data region was 1.5 nm. The value of the difference b is less than one-twelfth of the thickness of the ferromagnetic layer, 20 nm. The DTR media was installed into a drive as shown in FIG. 8. Then, read/write (R/W) evaluations were performed at a flying height of 13 nm and a rotation speed of 4,200 rpm using a flying magnetic head. All the ferromagnetic layer within 5 μm in the down-track direction was subjected to DC erase by band erase to magnetize the servo patterns in one direction. A write operation was performed at 100 MHz, and BER (bit error rate) was then measured. As a result, the BER was 10⁻⁶, which indicates that one error occurs per 10⁶ read and write operations. Therefore, the apparatus had sufficient reliability.

### Comparative Example 1

A discrete track media was produced using a general manufacturing method. That is, wet filling with SOG was employed for the step of filling the recesses between the patterns of the ferromagnetic layer with the nonmagnetic material. A DTR media was thus produced in which the ferromagnetic layer and the nonmagnetic material filled into the recesses had the same height all over the disk surface. The DTR media was installed into a drive and evaluations similar to those in Example 1 were performed. As a result, the BER was 10⁻⁴. This is probably due to the following reason. Since the ferromagnetic layer and the nonmagnetic material had the same height, the flying height of the magnetic had to be increased in order to avoid contact of the magnetic head with the burst zone. Therefore, the magnetic head could not properly write data to the ferromagnetic layer with a high coercivity of 5 kOe.

A comparison of Example 1 with Comparative Example 1 indicates that when the nonmagnetic material filled into the recesses in the data region is lower than that in the burst zone, the flying height of the magnetic head can be varied to enable sufficient recording to the high-coercivity media of 5 kOe, thus achieving sufficient reliability.

### Comparative Example 2

A stamper was used in which the ratio of the track width to the groove width was 1 to 1, in other words, in which the area ratio of the nonmagnetic material to the ferromagnetic layer in the data region was designed to be higher than that in Example 1. A DTR media was manufactured using a method similar to that used in Example 1 except for the above conditions. Measurements of sectional TEM indicated that the ferromagnetic layer and the nonmagnetic material filled into the recesses had the same height in the burst zone but that the nonmagnetic material filled into the recesses was lower than the ferromagnetic layer by 5 nm in the data region. A write operation was performed at 100 MHz, and the BER was then measured. As a result, the BER was 10⁻⁴. This is probably because the ratio of the track width to the groove width set at 1 to 1 serves to reduce the volume of the ferromagnetic layer and thus the SNR of read signals. These results indicate that a large difference b in the height of the nonmagnetic material between the burst zone and the data region does not always bring about good performance and that the difference must be within the range of 0<b≦a/12, which is determined taking the balance of the whole performance into account.

### Example 2

The experiment described below was conducted in order to examine the magnetic head for vibration that may occur if there is a large difference b in the height of the nonmagnetic material between the burst zone and the data region.

As shown in FIG. 9, a DTR media was manufactured in which no servo patterns were formed, while only the data regions are processed. As shown in FIG. 10A, protrusions and recesses are present in the data region. However, as shown in FIG. 10B, the burst zone is formed into a mirror state. A milling time was varied to produce three types of DTR media in which the protrusions had a height of 20, 15, or 10 nm in the data region. The height of the protrusions corresponds to the difference b in the height of the nonmagnetic material between the burst zone and the data region. A laser Doppler vibrometer (LDV) was used to observe the head flying. For the DTR media with 20 nm of b value, vibration of 9 kHz was observed which corresponded to a frequency of 100 sectors of serve zones. On the other hand, for the DTR media with 15 or 10 nm of b value, the vibration was not observed. The results indicate that the magnetic head itself is vibrated significantly if the difference b in the height of the nonmagnetic material exceeds 15 nm. Therefore, the difference in the height of the nonmagnetic material is preferably set at 15 nm or less.

### Example 3

Besides SiO₂, Au, Ag, Cu, C, CN, Si₃N₄, BN, TiN, SION, SiC, BC, TiC, or Al₂O₃ was used as a nonmagnetic filling agent. A DTR media was produced in a manner similar to that used in Example 1 except for this condition.

When Au, Ag, or Cu was used as the filling agent, both the data region and burst zones had a flat filled structure owing to reflow. When C, CN, Si₃N₄, BN, TiN, SiON, SiC, BC, TiC, or Al₂O₃ was used as the filling agent, sectional TEM observation showed that the DTR media produced had the structure shown in FIGS. 2A and 2B. However, in these DTR media, the film was stripped off the disk surface in places. Here, when C was used as the filling agent, the film strip-off occurred only in a relatively small number of places. These results are probably due to the difference in adhesion between the patterned resist (SOG) and the filling agent. That is, SOG and SiO₂ are substantially the same material and adhere excellently to each other. However, the other materials doe not exhibit a good adhesion. Of these materials, C exhibits a better adhesion, which is worse than that of SiO₂.

These results indicate that SiO₂ is preferably used as the nonmagnetic filling agent in order to maintain the reliability of the entire disk surface but that the DTR media according to embodiments of the present invention can also be manufactured using C, CN, Si₃N₄, BN, TiN, SiON, SiC, BC, TiC, or Al₂O₃.

### Example 4

SiO₂ was used as a nonmagnetic filling agent to manufacture 100 DTR media by a method similar to that used in Example 1. When glide tests were conducted, AE (Acoustic Emission) outputs were observed in 80 samples. The samples in which the AE outputs were observed were rejected. This is probably due to dust occurring during the SiO₂ bias-sputtering. This is because the RF sputtering involves unstable discharging and a bias voltage is applied to the substrate, which prevents sputter discharge conditions from being kept constant.

When SiO₂ was used as the nonmagnetic filling agent and normal sputtering was carried out at a high pressure (7.7 Pa) to deposit a film to a thickness of 100 nm, the same structure as that in Example 1 could be formed. This method was used to manufacture 100 DTR media. In glide tests, AE outputs were observed in 40 samples (defectives). This is because the bias sputtering was changed to the normal sputtering to enable significant reduction in the probability of dust occurring during the filling step.

Moreover, the nonmagnetic filling agent was changed to C (carbon). Normal sputtering was carried out at a high pressure (7.7 Pa) to deposit a film to a thickness of at least 100 nm, thus filling the recesses. AE outputs were observed in 5 (defectives) of the 100 DTR media manufactured. Carbon is used as a protective film for the HDD media and has established sputter conditions. Thus, carbon sputtering is much more stable than SiO₂ sputtering and involves almost no dust.

The above results can be summarized as follows. To set the nonmagnetic material filled into the recesses in the data region lower than that in the burst zone, the easiest way is to use SiO₂ as the nonmagnetic filling agent and to carry out bias-sputtering for filling. However, this may reduce acceptance rate to about 20% and is not suitable for mass production. On the other hand, carbon is inferior to SiO₂ in the effect of setting the nonmagnetic material filled into the recesses in the data region lower than that in the burst zone. However, the acceptance rate can be increased up to 95% using carbon, by carrying out the filling step using normal sputtering which involves only a small amount of dust in operation and which exhibits high process stability. Thus, in view of mass production, carbon is suitably used as the filling agent.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A discrete track media comprising:
a nonmagnetic substrate; and
a magnetic recording layer provided on the nonmagnetic substrate and comprising a data region including a recording track and a servo region including a preamble zone, an address zone and a burst zone, the data region and the servo region include patterns of a ferromagnetic layer forming protrusions and a nonmagnetic material filled into recesses between the patterns of the ferromagnetic layer,
wherein a height of the nonmagnetic material filled into the recesses in the data region is lower than that in the burst zone.

2. The discrete track media according to claim 1, wherein a difference b in the height between the nonmagnetic material filled into the recesses in the burst zone and that in the burst zone and a depth a of the recesses between the patterns of the ferromagnetic layer satisfy the following formula:
0<b≦a/12.

3. The discrete track media according to claim 2, wherein a value for b is 15 nm or less.

4. The discrete track media according to claim 1, wherein an area ratio of the nonmagnetic material to the ferromagnetic layer in the data region is larger than that in the burst zone.

5. The discrete track media according to claim 1, wherein the nonmagnetic material is SiO₂.

6. The discrete track media according to claim 1, wherein the nonmagnetic material is carbon.

7. A method of manufacturing a discrete track media, comprising:
forming a ferromagnetic layer and a protective layer on a nonmagnetic substrate;
applying a resist to the protective layer;
imprinting a stamper, having patterns of protrusions and recesses corresponding to a recording track, a preamble zone, an address zone and a burst zone, onto the resist so as to transfer the patterns to the resist;
carrying out dry-etching to selectively remove bottoms of the recesses in the resist to which the patterns of the protrusions and recesses have been transferred;
ion-beam etching the protective layer and the ferromagnetic layer using the patterned resist as a mask;
carrying out sputtering to fill a nonmagnetic material into the recesses between patterns of the ferromagnetic layer with the patterned resist remained on the protective layer; and
performing etchback to reduce a thickness of the nonmagnetic material.

8. The method according to claim 7, wherein an area ratio of the nonmagnetic material to the ferromagnetic layer in the data region is larger than that in the burst zone.

9. The method according to claim 7, wherein a height of the nonmagnetic material filled into the recesses in the data region is made lower than that in the burst zone, when the nonmagnetic material is filled into the recesses between the patterns of the ferromagnetic layer by sputtering.

10. The method according to claim 9, wherein a difference b in the height between the nonmagnetic material filled into the recesses in the burst zone and that in the burst zone and a depth a of the recesses between the patterns of the ferromagnetic layer satisfy the following formula:
0<b≦a/12.

11. The method according to claim 10, wherein a value for b is 15 nm or less.

12. The method according to claim 7, wherein the resist is spin-on-glass.

13. The method according to claim 7, wherein the nonmagnetic material is SiO₂.

14. The method according to claim 7, wherein the nonmagnetic material is carbon.
